(19) United States
(12) Patent Application Publication
(10) Pub. No.: US 2010/0242596 A1
(43) Pub. Date: Sep. 30, 2010

(54) APPARATUS FOR GAUGING AMOUNT OF FUEL FOR VEHICLE

(76) Inventors: Jae Seung Park, Daejun (KR); In Seok Sohn, Chungbuk (KR); Ha Young Cho, Chungnam (KR); Mun Sik Jeon, Chungbuk (KR); Chan Heum Yoon, Chunnam (KR)

Correspondence Address: MAXON IP LLC, 46175 WESTLAKE DR., SUITE 410, POTOMAC FALLS, VA, 20165, US

(21) Appl. No.: 12/594,871

(22) PCT Filed: Aug. 13, 2007
(86) PCT No.: PCT/KR07/03867

§ 371 Date: Oct. 6, 2009

(30) Foreign Application Priority Data
Jun. 7, 2007 (KR) 10-2007-0055355

(51) Int. Cl. G01F 23/30

(52) U.S. Cl. 73/305

(57) ABSTRACT

The present invention provides the fuel indication gauge that uses the materials of contact point and electrode conductor that have the strong corrosion, fuel resistance and chemical resistance. Especially, it provides the fuel quantity gauge that satisfies the requirements of various kinds of fuels in the world including poor quality of fuels and fuels that customers of vehicle manufacture companies require a test.

### TECHNICAL FIELD

The present invention is about a fuel gauge for vehicle, in detail, it is about a fuel gage that can improve working efficiency by improving the materials of the electrode of substrate and contact of wiper so that it can protect fluctuate of the resistance.

In general, the fuel gauge for vehicle is a device that is attached on the inside of the fuel tank and measures and shows the amount of fuel.

This kind of fuel gauge for vehicle is consist of a float that goes up and down according to the amount of saved fuel in the fuel tank, an wiper that is connected to the float and moves when the float goes up and down, a substrate that detects resistance in the case where the above the contact point of the above wiper is touched in order of precedence to the outside of the substrate.

For the structure of this kind of fuel gauge for vehicle, when the float is up and down according to the level of the fuel, by wiper's turning, the contact is movable contacted to the many electrodes that is located on the substrate, and at that time, the value of resistance in the resistance floor that is connected to the electrode is changed, and it detects the quantity of the fuel.

### BACKGROUND ART

As above, because the value of resistance is detected by the real touch of the contact of wiper and the electrode of the substrate, the contact and electrode should be consisted of the conductivity materials.

Therefore, for the contact above, an alloy of silver or copper, which the conductivity is good and electricity resistance is small, is usually used.

For the general material of the contact part (6), alloys of silver and copper (AgCu), silver and nickel (AgNi), silver and palladium (AgPd), silver, copper and nickel (AgCuNi), copper and nickel (CuNi), bronze, zinc and nickel (CuZnNi), silver, palladium and copper (AgPdCu) are used, and in the general fuel, it is combined with sulfur and corroded, and according to this, does not become safe.

Even though the materials that is combined with sulfur and is not corroded, alloy of copper and nickel (CuNi) that does not have silver (Ag) above, copper and nickel (CuNi) that does not have silver (Ag) above, bronze, zinc and nickel (CuZnNi) are used, they are comparatively safe to the general fule, but for the elemental sulfur fule, bio diesel, main ingredients of alcohol (E85), peroxide fuel, corrosive E22 fuel, chemical resistance is low, and is corroded and correct fuel indication is not happened.

For the general gas or gasoline, the sulfuration that sulfur is reacted with silver (Ag) and happened, is the main cause of corrosion, but for the bio diesel or main ingredient material of alcohol (E85), the contact that has corrosion or chemical resistance is needed.

Generally, for the contact, alloy of silver (Ag) and little bit of palladium (Pd) is used, or alloy of silver (Ag) and copper (Cu), nickel (Ni), or zinc (Zn), and keep steady hardness and abrasion and sliding.

For the electrode of a conductor, alloy of silver containing glass is usually used.

However, for the case where you combine the contact and electrode and use them as above, because it makes chemical effect with sulfur ingredient or oxidation ingredient in the fuel of vehicle and it is corroded and the irregular corrosion resistant is happened, so it bothers pointing out the correct fuel level.

For the fuel gauge for vehicles, an example was displayed in the U.S. Pat. No. 6,591,629 (the applicant of patent: Densor Inc.) that was made an application and registered as “a slide detector” in America,

The electrode that is applied to the fuel gauge for vehicle that was recorded in the above registered patent is made of alloy of silver containing glass or alloy of silver containing palladium (Pd), and contact is made of gold ingredient, or alloy of gold containing cobalt, palladium, or nickel ingredient.

However, because for this kind of structure of the fuel gauge for vehicle, alloy of silver is used for the electrode or contact, there is problem that can not satisfy the corrosion resistance, chemical resistance, and endurance resistance that vehicle companies recently require and that the safeness of function is lower.

As a different example that is applied and registered as “the equipment which can detect the surface” Patent No. 2001-0033652 (open on Apr. 25, 2001, applicant: Nippon Seiki Inc.), for the contact in the open patent above, in order to improve the deterioration by sulfuration in the fuel, because silver is an important element of sulfuration, they tried to prevent the furious flames of contact with the alloy of gold that does not contain silver, and for the alloy that does not contain silver, there are various of alloys, but they present alloy of copper, nickel and zinc (CuNiZn) and alloy of alloy of copper nickel (CuNi) that gold is comparatively low price and furious flames are high.

Especially, they explain that the alloy of copper, nickel and zinc, suppresses the oxidation by zinc (Zn), and that it has tolerance to alcohol and moisture.

The electrode of the open patent is generally made of alloy of silver and palladium (AgPd), and they establish the rate of palladium (Pd) as about 40% and above 40%, and comparing with the below 40%, it has better furious flames resistance.

However, in the general fuel, this kind of contact and electrode indicates good corrosion resistance and endurance resistance, but it is not enough to satisfy the corrosion resistance, chemical resistance, and high endurance length about various fuels or test fuel that recent vehicle companies request.

### DISCLOSURE

### Technical Problem

The present invention, fuel gauge (an apparatus for gauging amount of fuel for vehicle) is consist of float that slides according to the amount of fuel in the fuel tank, contact part of wiper that is connected and established to arm that moves according to the operation of the float, an electrode conductor that the contact slides, and substrate that an electrode conductor is printed.

In this invention, since the contact part is consist of alloy of palladium or only palladium itself, it uses the palladium as the most important ingredient, and the chemical reaction becomes stable and has good corrosion resistance and fuel resistance in the general gas and light gas, biodiesel alcohol fuel (E20-25, E85 and so on), a poor quality fuel which is oxidation, elemental sulfur fuel, corrosive E22 fuel, and peroxide fuel that a subcontract company which makes a vehicle request, so that it can indicate the exact amount of fuel.

Generally, an electrode conductor that the contact slides mentioned in the background technology part, is made of a system of electrode which alloys silver (Ag) as an important ingredient with adding 20% or 35% of palladium (Pd), but this invention does not use silver but alloy of palladium (palladium alloy electrode) as the most important element, and it is made of palladium alloy, and the amount of palladium as 55% or 65% of it and adds the amount of silver (Ag) ingredient as 35% or 45% are made of it.

When the palladium alloy electrode is made as 70% or above of palladium (Pd), the quality of printing reduces when it is printed on the substrate, and when the substrate is made through the progress of plasticity the power of adhesion from the substrate of an electrode conductor is much lower than this invention.

If the adhesion becomes lower, according to the contact slides to the electrode in the fuel, there is a defect that does not have endurance resistance.

Also, when the main palladium alloy electrode is made as below 50%, various materials, such as biodiesel, alcohol fuel (E20-25, E85 and so on), a poor quality fuel which is oxidation, elemental sulfur fuel, corrosive E22 fuel, and peroxide fuel that a subcontract company which makes a vehicle request, so that it can indicate the exact amount of fuel.

### Technical Solution

In this invention, since the contact part is consist of alloy of palladium or only palladium itself, it uses the palladium as the most important ingredient, and the chemical reaction becomes stable and has good corrosion resistance and fuel resistance in the general gas and light gas, biodiesel alcohol fuel (E20-25, E85 and so on), a poor quality fuel which is oxidation, elemental sulfur fuel, corrosive E22 fuel, and peroxide fuel that a subcontract company which makes a vehicle request, so that it can indicate the exact amount of fuel.

Generally, as explained in the Background Technology? an electrode conductor that the contact slides mentioned in the background technology part, is made of a system of electrode which alloys silver (Ag) as an important ingredient with adding 20% or 35% of palladium (Pd), but this invention does not use silver but alloy of palladium (palladium alloy electrode) as the most important element, and it is made of palladium alloy, and the amount of palladium as 55% or 65% of it and adds the amount of silver (Ag) ingredient as 35% or 45% are made of it.

### ADVANTAGEOUS EFFECTS

The figures of [Examples] are graphs showing the research results according to the materials of electrode and contact point of fuel gauge for vehicle and figures of too much abrasion of an electrode conductor and a secession of an electrode

### Example 1

Example 1. shows the results of operation process in the various fuel situation that can impact to an equipment which detect fuel through an equipment which detects fuel quantity that is combined with the palladium (Pd) electrode and palladium (Pd) contact point, and as you can see in the example,

An equipment which detects fuel quantity in the present invention does not have change of outcome in the elemental sulfur, peroxide, corrosive E22, E85, and biodiesel 20%, and we can confirm that it keeps the inside operation in a stable situation.

The materials of contact part in the examples are palladium (Pd) electrode and palladium alloy contact.

### Examples

### Example 1

### Fuel Gauge Equipped with Palladium (Pd) Alloy Contact to a Palladium (Pd) System of Electrode

### Example 2

Example 2 is a result of testing endurance resistance about elemental sulfur through the palladium alloy contact point in the silver system of electrode {below of 50% Pd}, and you can see from the result of examples, we can see that too much silver (Ag) ingredient creates abrasion and a layer which corrodes to an electrode, and it changes a signal which output of the power of an equipment which detects fuel quantity.

The contact part material in the example is equipment which detects fuel quantity that is combined with silver (Ag) and palladium (Pd) alloy contact.

### Example 2

### Fuel Gauge Equipped with Silver (Ag) Electrode and Palladium (Pd) Alloy Contact

### Example 3

Example 3 shows the practical example about endurance resistance in the elemental sulfur fuel of equipment which detect fuel that is combined with the palladium (Pd) electrode and silver alloy contact.

Even though palladium (Pd) electrode that has endurance resistance is used, if you use silver (Ag) alloy for the contact, it will make a change a signal which output of the power of an equipment which detects by corrosion.

The material of contact part that is applied in the example is equipment which detects fuel quantity that is formed with palladium (Pd) electrode and silver (Ag) alloy contact.

### Example 3

### Fuel Gauge that is Equipped with Silver (Ag) Alloy Contact to a Palladium (Pd) Electrode

### Example 4

Example 4 shows the practical example about endurance resistance in the elemental sulfur fuel of equipment which detects fuel quantity that is equipped with contact of copper nickel zinc alloy (CuNiZn) that is used as palladium electrode and a low price contact.

Even though palladium (Pd) electrode that has endurance resistance is used, if you use copper nickel zinc (CuNiZn) alloy for the contact, it will make a change a signal which output of the power of an equipment which detects by lack of chemical protective and corrosion.

The material of contact part that is applied in the example is equipment which detects fuel quantity that is formed with palladium (Pd) electrode and copper nickel zinc (CuNiZn) alloy contact.

### Example 4

### Fuel Gauge Equipped with Cooper Nickel Zinc (CuNiZn) Contact to a Palladium (Pd) Alloy Electrode

### Example 5

### Example 5

Example 5 shows the practical example about endurance resistance in the elemental sulfur fuel of equipment which detects fuel quantity that is equipped with contact of copper nickel zinc alloy (CuNiZn) that is used as silver (Ag) electrode and a low price contact.

For the cooper nickel zinc (CuNiZn) contact and silver (Ag) electrode, there is bigger change in a signal which output of the power of an equipment which detects than other examples, for both electrode and contact are not good for chemical protective and corrosion.

The material of contact part that is applied in the example is equipment which detects fuel quantity that is formed with silver (Ag) system electrode (below 50% of palladium (Pd) and copper nickel zinc (CuNiZn) alloy contact that does not contain silver (Ag).

### Example 5

### Fuel Gauge Equipped with Cooper Nickel Zinc (CuNiZn) Contact to a Silver (Ag) System Electrode

### Example 6

### Figure about a Phenomenon which Secedes a Electrode by Lack of Adhesion with Over Abrasion and Substrate in the Electrode Conductor

### Example 6

As you can see in the example, an equipment which detects fuel quantity in the present invention does not have change of outcome in the elemental sulfur, peroxide, corrosive E22, E85, and biodiesel 20%, and we can confirm that it keeps the inside operation in a stable situation, and it solves the problem of previous equipment which detects fuel quantity with combination of silver (Ag) electrode and palladium (Pd) alloy contact, with combination of palladium (Pd) electrode and silver (Ag) alloy contact, with combination of palladium (Pd) electrode and cooper nickel zinc (CuNiZn) contact, with combination of silver (Ag) electrode and cooper nickel zinc (CuNiZn) contact that does not contain silver (Ag).

### DESCRIPTION OF DRAWINGS

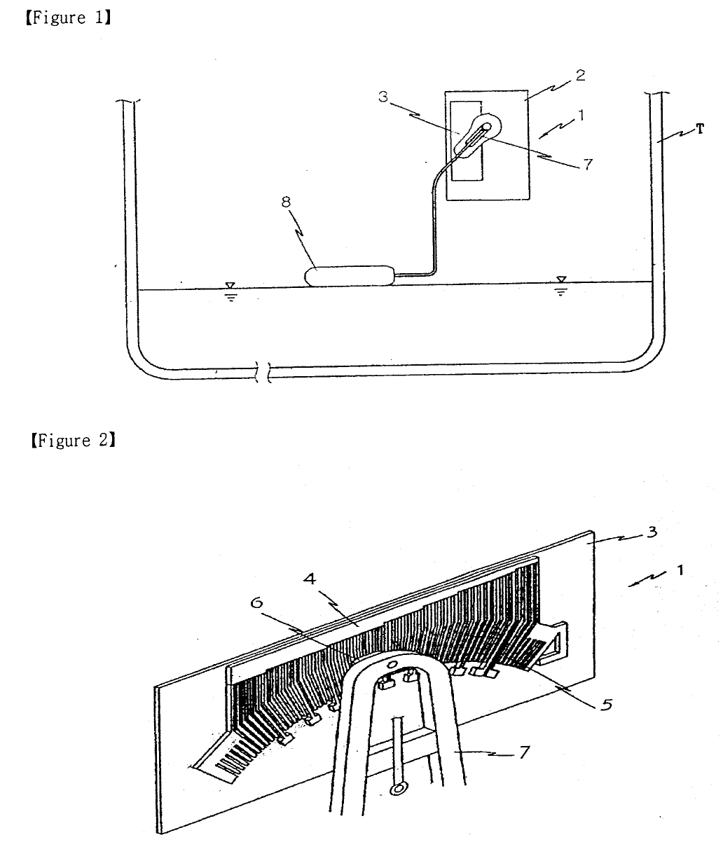

FIG. 1. is a figure of structure simply shows the structure of fuel gauge for vehicle according to the examples of the present invention.

FIG. 2. is a squint figure of a part situation showing the situation of contacting of contact of wiper and electrode placed on the substrate of an apparatus for gauging amount of fuel for vehicle presented in the FIG. 1.

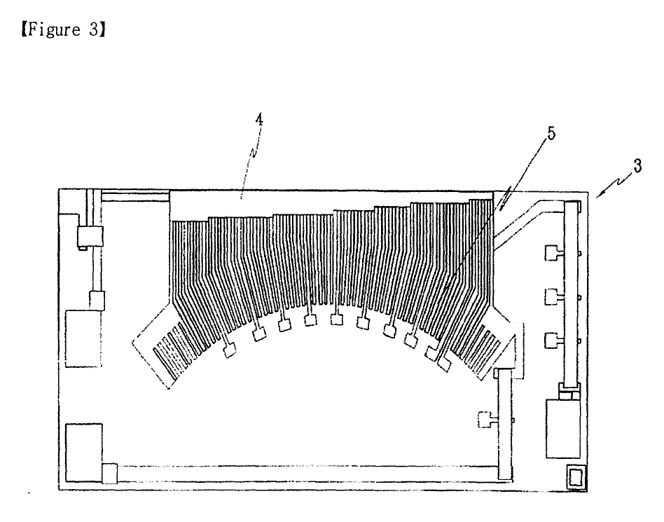

FIG. 3. is a front figure showing a substrate of fuel gauge for vehicle presented in the FIG. 2.

| | |
|---|---|
| 1. | fuel gauge for vehicle |
| 2. | plate of support |
| 3. | substrate |
| 4. | a resistance layer |
| 5. | electrode |
| 6. | contact |
| 7. | wiper |
| 8. | float |
| T. | fuel tank |

### BEST MODE

In this invention, since the contact part is consist of alloy of palladium or only palladium itself, it uses the palladium as the most important ingredient, and the chemical reaction becomes stable and has good corrosion resistance and fuel resistance in the general gas and light gas, biodiesel alcohol fuel (E20-25, E85 and so on), a poor quality fuel which is oxidation, elemental sulfur fuel, corrosive E22 fuel, and peroxide fuel that a subcontract company which makes a vehicle request, so that it can indicate the exact amount of fuel.

Generally, an electrode conductor that the contact slides mentioned in the background technology part, is made of a system of electrode which alloys silver (Ag) as an important ingredient with adding 20% or 35% of palladium (Pd), but this invention does not use silver but alloy of palladium (palladium alloy electrode) as the most important element, and it is made of palladium alloy, and the amount of palladium as 55% or 65% of it and adds the amount of silver (Ag) ingredient as 35% or 45% are made of it.

### MODE FOR INVENTION

With the attached figures, the structure of fuel gauge for vehicle of the present invention will be explained in detail.

As presented in the FIG. 1., the fuel gauge for vehicle (1) that the present invention suggests is extended and formed from a substrate (3) equipped to plate of support (2) that is placed inside of fuel tank (T), a resistance layer that is placed on the substrate (3) above, and the resistance layer (4) above placed on the substrate (3), many electrode (5) that is formed with palladium alloy, metal type wiper (7) that equips can make hinge on the plate of support (2), that equips contact (6) contacting in order of precedence to many electrode (5) above when it move hinge, and that the contact (6) is consist of palladium system material ingredient, and float (8) that is equipped to inside of fuel tank (T) above, move up and down according to the fuel level, connected to the wiper (7) above, and engage the wiper (7) above.

For the fuel gauge for vehicle with this kind of structure, the plate of support (2) is equipped inside wall of the fuel tank (T).

And, the wiper (7) above is connected by float (8) and arm, and when the float (8) moves up and down according to the fuel level, the wiper (7) above interlocks and moves on substrate (3).

This kind of substrate (3) is equipped on the plate of support (2) and placed in order to be correspond to the wiper (7) above. The substrate (3) above contains ordinary substrate, and desirably it means ceramic substrate. And the resistance layer (4) that is placed on the substrate (3) above is continuously formed on the edge of the substrate (3), and it is formed with materials that has appropriate value of resistance.

Also, many electrode (5) is extended and formed as parallel from the resistance layer (4) and discontinuously placed.

Therefore, when the wiper (7) above is engaged to the float (8) and turn on the substrate (3), the contact (6) of wiper (7) in order of precedence contacts to many electrode (5) that are discontinuously placed and moves, each accumulation of value of resistance is detected from the continuously placed resistance layer (4), and by the detected valued of resistance, control part (not figured) calculates the quantity of fuel and mark on the instrument cluster (3).

In brief explanation of the process of making an electrode conductor, the progress of mixing, the progress of printing, the progress of drying, and the progress of plasticity. For the progress of plasticity, it is done on the 850 Celsius degree, and keeps the temperature profile of rising temperature, maintenance, and descent, and it takes about 40 minutes.

Because palladium (Pd) has higher temperature melting point comparing with silver (Ag), the alloy of proper contained quantity of silver (Ag) that has low melting point to the palladium (Pd) type metal provides good temperature and time profile (temperature and time considering economy of temperature and time).

What is claimed is:

1-6. (canceled)

7. Fuel gauge apparatus installed in a fuel tank for measuring a fuel quantity comprising:
a substrate disposed in the tank which contains liquid fuel;
a resistive layer provided on the substrate;
a plurality of electrodes arranged to extend from the resistive layer on the substrate;
a wiper having a contact which slides on the plurality of electrodes, the wiper being disposed on the substrate; and
a float displaced in accordance with a displacement of surface of the liquid, the float being connected to the wiper, wherein the wiper has the contact slide on the electrodes in accordance with the displacement of the float, wherein the plurality of electrodes are made of an alloy consisting of 56.5-65% by weight of palladium (Pd) and 35-43.5% by weight of silver (Ag) containing glass particles, and wherein the contact is made of an alloy consisting of 90-99.5% by weight of palladium (Pd) and 0.5-10% by weight of either gold (Au) or platinum (Pt) for corrosion resistance, chemical resistance, fuel resistance, and durability performance.
